(19) United States
(12) Patent Application Publication
(10) Pub. No.: US 2024/0423769 A1
(43) Pub. Date: Dec. 26, 2024

(54) Water-Flossing Mouthpiece Device

(71) Applicant: Bryon Bonnell, Payette, ID (US)

(72) Inventor: Bryon Bonnell, Payette, ID (US)

(21) Appl. No.: 18/675,237

(22) Filed: May 28, 2024

Related U.S. Application Data
(60) Provisional application No. 63/522,213, filed on Jun. 21, 2023.

(51) Int. Cl. A61C 17/028

(52) U.S. Cl. CPC A61C 17/028

(57) ABSTRACT

A water-flossing mouthpiece device is provided. The device is comprised of a mouthpiece with at least one teeth-receiving area and at least one opening. The mouthpiece can be placed into a user's mouth and then a tubing of the device can be secured to a water source. The water source can then be turned on to allow water to flow through the tubing and out of the openings in the mouthpiece in order to water-floss the user's teeth. The device may also be comprised of a drainage tube to allow collected water in the user's mouth to drain back into a sink or secondary location.

### CROSS-REFERENCE TO RELATED APPLICATION

The present application claims priority to, and the benefit of, U.S. Provisional Application No. 63/522,213, which was filed on Jun. 21, 2023, and is incorporated herein by reference in its entirety.

### FIELD OF THE INVENTION

The present invention relates generally to the field of flossing devices. More specifically, the present invention relates to a water-flossing mouthpiece device that provides a mouthpiece that can be inserted into the mouth of the user and attached to a water source such that water is expelled through openings of the mouthpiece in order to water-floss the user's teeth. Accordingly, the present disclosure makes specific reference thereto. Nonetheless, it is to be appreciated that aspects of the present invention are also equally applicable to other like applications, devices, and methods of manufacture.

### BACKGROUND

The use of traditional string floss can present significant obstacles for a substantial portion of the population. Individuals may find it particularly challenging to manipulate the floss, leading to discomfort or even the avoidance of flossing altogether. This issue is exacerbated for those with physical limitations, arthritis, or other conditions that impair manual dexterity, as well as for those with closely spaced teeth where string floss can be difficult to slide into place without causing discomfort or gum damage. Similarly, toothbrushes are ineffectual when it comes to the critical task of flossing food particles and plaque from the tight crevices between teeth. This deficiency can leave harmful bacteria to flourish, potentially leading to tooth decay, gum disease, and bad breath, which undermines overall dental health.

Therefore, there exists a long-felt need in the art for an improved flossing device. There also exists a long-felt need in the art for a water-flossing mouthpiece device. More specifically, there exists a long-felt need in the art for a water-flossing mouthpiece device wherein the device allows a user to water-floss their teeth. In addition, there exists a long-felt need in the art for a water-flossing mouthpiece device wherein the device allows a user to water-floss their teeth while not requiring significant physical dexterity to use.

The subject matter disclosed and claimed herein, in one embodiment thereof, comprises a water-flossing mouthpiece device. The device is comprised of a mouthpiece with at least one teeth-receiving area and at least one opening. The mouthpiece can be placed into a user's mouth and then a tubing of the device can be secured to a water source. The water source can then be turned on to allow water to flow through the tubing and out of the openings in the mouthpiece in order to water-floss the user's teeth. The device may also be comprised of a drainage tube to allow collected water in the user's mouth to drain back into a sink or secondary location.

In this manner, the water-flossing mouthpiece device of the present invention accomplishes all the foregoing objectives and provides an improved flossing device. More specifically, the device allows a user to water-floss their teeth. While doing so, the mouthpiece does not require significant physical dexterity to use and to achieve flossing.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a water-flossing mouthpiece device comprised of a mouthpiece that can be attached to a sink or a pump device to receive water. The water is then expelled from at least one opening in the mouthpiece while the mouthpiece is inside the mouth of a user in order to floss between the user's teeth via water flossing.

The device is comprised of at least one attachment point that allows at least one tubing of the device to attach to a sink in order to receive water. The attachment point is comprised of at least one flow control that allows a user to allow/inhibit flow from the sink into the tubing during use. In another embodiment, the attachment point attaches to at least one attachment point of at least one pump device, which does not require the use of a sink. The pump device has at least one internal reservoir that can be filled with water, wherein the reservoir is in fluid communication with the attachment point. Then, at least one button of the pump device can be pressed to pump water from the reservoir to the attachment point via at least one pump.

The device may also be comprised of at least one compartment in fluid communication with the attachment point and mouthpiece via the tubing. The compartment may receive at least one water-dissolvable tablet that cleans the teeth of the user, kills bacteria, and freshens the breath of the user. In one embodiment, the tablet is comprised of a flavor, of any flavor type.

The mouthpiece is placed into a user's mouth while using the device. The mouthpiece may be made of a deformable material in one embodiment to allow the mouthpiece to take the exact shape of a user's mouth/teeth. The mouthpiece is comprised of at least one teeth-receiving area that receives the user's top and/or bottom teeth. The teeth-receiving area (or any other portion of the mouthpiece) is comprised of at least one opening that allows water to exit the mouthpiece such that the water is expelled between the user's teeth in order to water-floss said teeth. The mouthpiece may also be comprised of at least one drainage tube that allows the water collected in the user's mouth while using the device to drain into a sink or other secondary location while the user's mouth remains closed.

The present invention is also comprised of a method of using the device. First, a device is provided comprised of a mouthpiece comprised of at least one teeth-receiving area and at least one opening, at least one tubing comprised of at least one attachment point, and at least one drainage tube. Then, the attachment point can be secured to at least one sink. Then, at least one tablet can be placed in at least one compartment. Next, the mouthpiece can be placed into a user's mouth such that the user's top and/or bottom teeth contact the teeth-receiving area of the mouthpiece. Then, the drainage tube can be placed into a sink bowl or other secondary area. Finally, the sink can be turned on and the flow control can be opened to allow water to flow through the tubing, through the compartment (wherein the water dissolves the tablet), and into the mouthpiece wherein the water exits the opening and water flosses the teeth of the user.

The present invention is also comprised of a second method of using the device. First, a device is provided comprised of a mouthpiece comprised of at least one teeth-receiving area and at least one opening, at least one tubing comprised of at least one attachment point, at least one drainage tube, and a pump device comprised of at least one reservoir and at least one pump. Then, the attachment point can be secured to the pump device. Then, at least one tablet can be placed in at least one compartment. Next, the mouthpiece can be placed into a user's mouth such that the user's top and/or bottom teeth contact the teeth-receiving area of the mouthpiece. Then, the drainage tube can be placed into a sink bowl or other secondary area. Finally, the pump of the device can be activated and the flow control can be opened to allow water to flow from the reservoir, into the tubing, through the compartment (wherein the water dissolves the tablet), and into the mouthpiece wherein the water exits the opening and water-flosses the teeth of the user.

Accordingly, the water-flossing mouthpiece device of the present invention is particularly advantageous as it provides an improved flossing device. More specifically, the device allows a user to water-floss their teeth. While doing so, the mouthpiece does not require significant physical dexterity to use and to achieve flossing. In this manner, the water-flossing mouthpiece device overcomes the limitations of existing flossing devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a water-flossing mouthpiece device of the present invention in accordance with the disclosed architecture;

FIG. 2 illustrates a perspective view of an adapter and an attachment point of one potential embodiment of a water-flossing mouthpiece device of the present invention in accordance with the disclosed architecture;

FIG. 3 illustrates a perspective view of a mouthpiece and compartment of one potential embodiment of a water-flossing mouthpiece device of the present invention in accordance with the disclosed architecture;

FIG. 4 illustrates a front view of a pump device of one potential embodiment of a water-flossing mouthpiece device of the present invention in accordance with the disclosed architecture;

FIG. 5 illustrates a flowchart of a method of using one potential embodiment of a water-flossing mouthpiece device of the present invention in accordance with the disclosed architecture; and

FIG. 6 illustrates a flowchart of a method of using one potential embodiment of a water-flossing mouthpiece device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved flossing device. There also exists a long-felt need in the art for a water-flossing mouthpiece device. More specifically, there exists a long-felt need in the art for a water-flossing mouthpiece device wherein the device allows a user to water-floss their teeth. In addition, there exists a long-felt need in the art for a water-flossing mouthpiece device wherein the device allows a user to water-floss their teeth while not requiring significant physical dexterity to use.

The present invention, in one exemplary embodiment, is comprised of a water-flossing mouthpiece device. The device is comprised of a mouthpiece which can be attached to a sink or a pump device to receive water. The water is then expelled from at least one opening in the mouthpiece while the mouthpiece is inside the mouth of a user in order to floss between the user's teeth via water flossing.

The device is comprised of at least one attachment point. The attachment point allows at least one tubing of the device to attach to a sink in order to receive water. The attachment point is comprised of at least one flow control that allows a user to allow/inhibit flow from the sink into the tubing during use. In another embodiment, the attachment point attaches to at least one attachment point of at least one pump device, which does not require the use of a sink as the pump has at least one internal reservoir that can be filled with water, wherein the reservoir is in fluid communication with the attachment point. Then, at least one button of the pump device can be pressed to pump water from the reservoir to the attachment point via at least one pump.

The device may also be comprised of at least one compartment in fluid communication with the attachment point and mouthpiece via the tubing. The compartment may receive at least one water-dissolvable tablet that cleans the teeth of the user, kills bacteria, and freshens the breath of the user. In one embodiment, the tablet is comprised of a flavor, of any flavor type.

The mouthpiece is placed into a user's mouth while using the device. The mouthpiece may be made of a deformable material in one embodiment to allow the mouthpiece to take the exact shape of a user's mouth/teeth. The mouthpiece is comprised of at least one teeth-receiving area that receives the user's top and/or bottom teeth. The teeth-receiving area (or any other portion of the mouthpiece) is comprised of at least one opening that allows water to exit the mouthpiece such that the water is expelled between the user's teeth in order to water-floss said teeth. The mouthpiece may also be comprised of at least one drainage tube that allows the water collected in the user's mouth while using the device to drain into a sink or other secondary location while the user's mouth remains closed.

The present invention is also comprised of a method of using the device. First, a device is provided comprised of a mouthpiece comprised of at least one teeth-receiving area and at least one opening, at least one tubing comprised of at least one attachment point, and at least one drainage tube. Then, the attachment point can be secured to at least one sink. Then, at least one tablet can be placed in at least one compartment. Next, the mouthpiece can be placed into a user's mouth such that the user's top and/or bottom teeth contact the teeth-receiving area of the mouthpiece. Then, the drainage tube can be placed into a sink bowl or other secondary area. Finally, the sink can be turned on and the flow control can be opened to allow water to flow through the tubing, through the compartment (wherein the water dissolves the tablet), and into the mouthpiece wherein the water exits the opening and water flosses the teeth of the user.

The present invention is also comprised of a second method of using the device. First, a device is provided comprised of a mouthpiece comprised of at least one teeth-receiving area and at least one opening, at least one tubing comprised of at least one attachment point, at least one drainage tube, and a pump device comprised of at least one reservoir and at least one pump. Then, the attachment point can be secured to the pump device. Then, at least one tablet can be placed in at least one compartment. Next, the mouthpiece can be placed into a user's mouth such that the user's top and/or bottom teeth contact the teeth-receiving area of the mouthpiece. Then, the drainage tube can be placed into a sink bowl or other secondary area. Finally, the pump of the device can be activated and the flow control can be opened to allow water to flow from the reservoir, into the tubing, through the compartment (wherein the water dissolves the tablet), and into the mouthpiece wherein the water exits the opening and water-flosses the teeth of the user.

Accordingly, the water-flossing mouthpiece device of the present invention is particularly advantageous as it provides an improved flossing device. More specifically, the device allows a user to water-floss their teeth. While doing so, the mouthpiece does not require significant physical dexterity to use and to achieve flossing. In this manner, the water-flossing mouthpiece device overcomes the limitations of existing flossing devices known in the art.

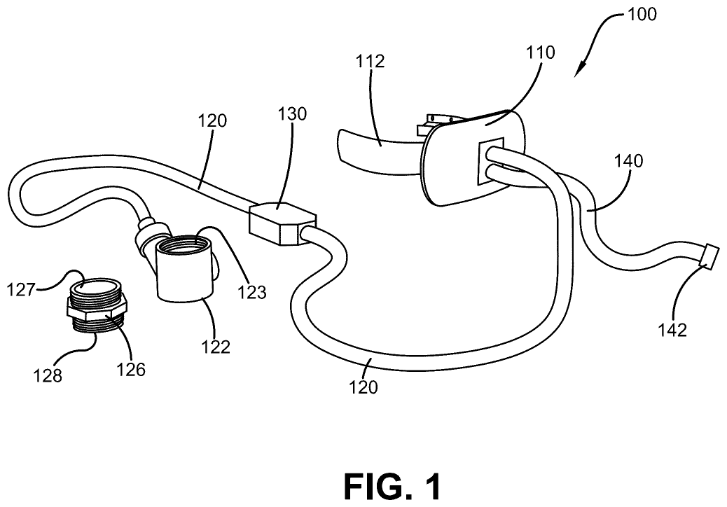

Referring initially to the drawings, FIG. 1 illustrates a perspective view of one potential embodiment of a water-flossing mouthpiece device 100 of the present invention in accordance with the disclosed architecture. The device 100 is comprised of a mouthpiece 110 which can be attached to a sink or a pump device 150 to receive water. The water is then expelled from at least one opening 114 in the mouthpiece 110 while the mouthpiece 110 is inside the mouth of a user in order to floss between the user's teeth via water flossing.

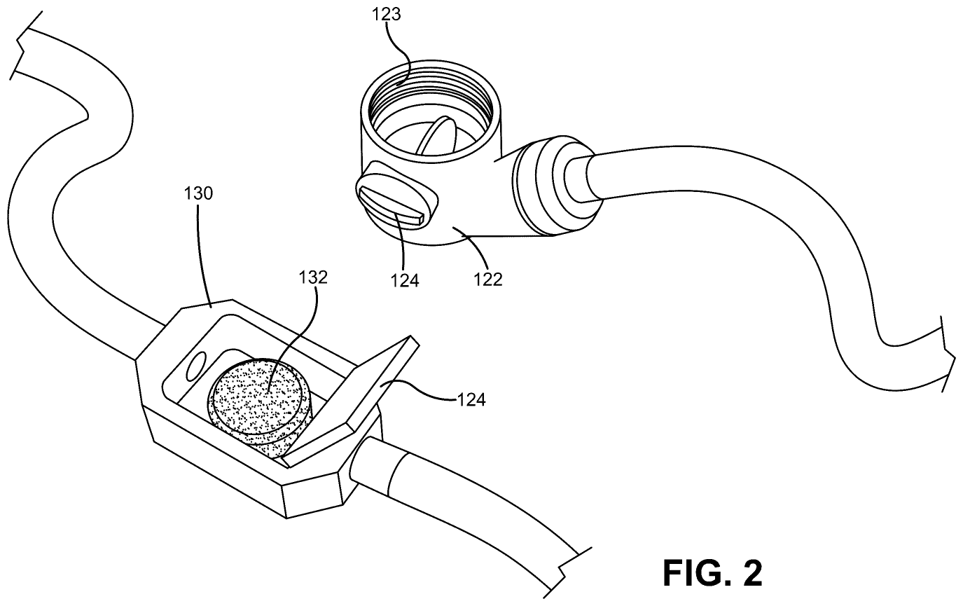

The device 100 is comprised of at least one attachment point 122, as seen in FIG. 2. The attachment point 122 allows at least one tubing 120 of the device 100 to attach to a sink in order to receive water. In one embodiment, the attachment point 122 is comprised of a plurality of male or female threads 123 in order to threadedly attach to the sink. In another embodiment, the point 122 may attach to the sink via any attachment mechanism/structure known in the art.

In the event that the diameter of the attachment point 122 differs from the diameter of the sink, the device 100 may be comprised of at least one adapter 126. The adapter 126 is comprised of a first threaded opening 127 of a first diameter that attaches to the sink and a second threaded opening 128 of a second diameter that attaches to the attachment point 122.

The attachment point 122 is comprised of at least one flow control 124. The control 124 allows a user to allow/inhibit flow from the sink into the tubing 120 during use. The control 124 may be in the form of any flow control 124 structure known in the art, such as, but not limited to, a switch, a button, etc.

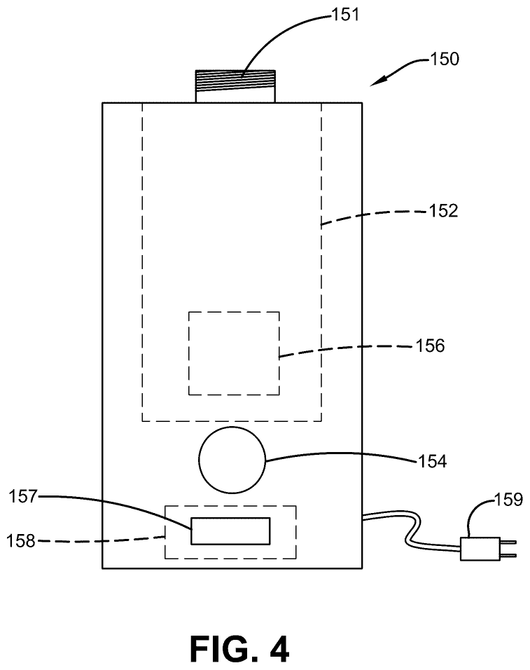

In another embodiment, the attachment point 122 attaches to at least one attachment point 151 (which is preferably a threaded attachment point) of at least one pump device 150 (as seen in FIG. 4), which does not require the use of a sink. The pump device 150 has at least one internal reservoir 152 that can be filled with water 152, wherein the reservoir 152 is in fluid communication with the attachment point 151. Then, at least one button 154 of the pump device 150 can be pressed to pump water from the reservoir 152 to the attachment point 122 via at least one pump 156. The pump 156 is preferably an electric pump powered by at least one battery 158. The battery 158 may be removable or non-removable and may be disposable or rechargeable in different embodiments. In one embodiment, the battery 158 receives power via a power cord 159. In another embodiment, the battery 158 can be recharged via at least one charging port 157, such as, but not limited to, a USB charging port.

The device 100 may also be comprised of at least one compartment 130. The compartment 130 is in fluid communication with the attachment point 122 and mouthpiece 110 via the tubing 120. The compartment 130 may receive at least one water-dissolvable tablet 132. The tablet 132 preferably has a composition that cleans the teeth of the user, kills bacteria, and freshens the breath of the user. In one embodiment, the tablet 132 is comprised of a flavor, of any flavor type. To secure the tablet 132 within the compartment 130, the compartment 130 is comprised of at least one water-tight lid 134.

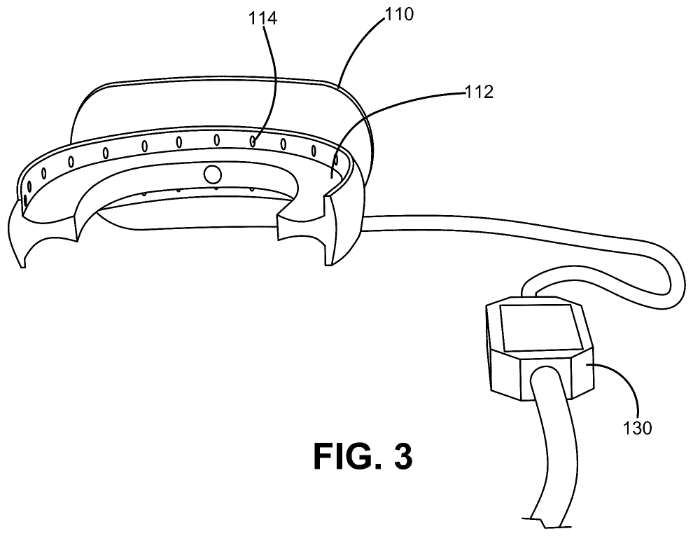

The mouthpiece 110 is placed into a user's mouth while using the device 100, as seen in FIG. 3. The mouthpiece 110 may be made of a deformable material in one embodiment to allow the mouthpiece 110 to take the exact shape of a user's mouth/teeth. The mouthpiece 110 is comprised of at least one teeth-receiving area 112 that receives the user's top and/or bottom teeth. The teeth-receiving area 112 (or any other portion of the mouthpiece 110) is comprised of at least one opening 114. The opening 114 allows water to exit the mouthpiece 110 such that the water is expelled between the user's teeth in order to water-floss said teeth. The openings 114 may be in any arrangement, orientation, and manner to accomplish said water-flossing in different embodiments.

The mouthpiece 100 may also be comprised of at least one drainage tube 140. The tube 140 allows the water collected in the user's mouth while using the device 100 to drain into a sink or other secondary location while the user's mouth remains closed. In one embodiment, the drainage tube 140 is comprised of at least one cap 142 to seal the tub 140 when not in use.

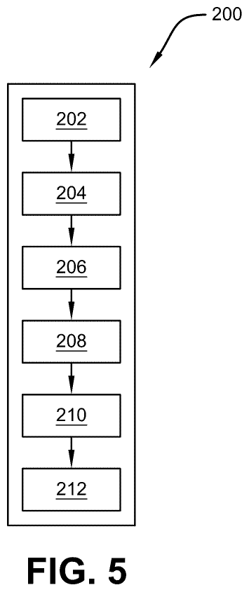

The present invention is also comprised of a method of using 200 the device 100, as seen in FIG. 5. First, a device 100 is provided comprised of a mouthpiece 110 comprised of at least one teeth-receiving area 112, and at least one opening 114, at least one tubing 120 comprised of at least one attachment point 122, and at least one drainage tube 140 [Step 202]. Then, the attachment point 122 can be secured to at least one sink [Step 204]. Then, at least one tablet 132 can be placed in at least one compartment 130 [Step 206]. Next, the mouthpiece 110 can be placed into a user's mouth such that the user's top and/or bottom teeth contact the teeth-receiving area 112 of the mouthpiece 110 [Step 208]. Then, the drainage tube 140 can be placed into a sink bowl or other secondary area [Step 210]. Finally, the sink can be turned on and the flow control 124 can be opened to allow water to flow through the tubing 120, through the compartment 130 (wherein the water dissolves the tablet 132), and into the mouthpiece 110 wherein the water exits the opening 114 and water-flosses the teeth of the user [Step 212].

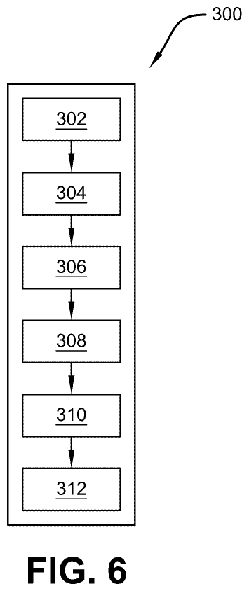

The present invention is also comprised of a second method of using 300 the device 100, as seen in FIG. 6. First, a device 100 is provided comprised of a mouthpiece 110 comprised of at least one teeth-receiving area 112 and at least one opening 114, at least one tubing 120 comprised of at least one attachment point 122, at least one drainage tube 140, and a pump device 150 comprised of at least one reservoir and at least one pump 156 [Step 302]. Then, the attachment point 122 can be secured to the pump device 150 [Step 304]. Then, at least one tablet 132 can be placed in at least one compartment 130 [Step 306]. Next, the mouthpiece 110 can be placed into a user's mouth such that the user's top and/or bottom teeth contact the teeth-receiving area 112 of the mouthpiece 110 [Step 308]. Then, the drainage tube 140 can be placed into a sink bowl or other secondary area [Step 310]. Finally, the pump 156 of the device 150 can be activated and the flow control 124 can be opened to allow water to flow from the reservoir 152, into the tubing 120, through the compartment 130 (wherein the water dissolves the tablet 132), and into the mouthpiece 110 wherein the water exits the opening 114 and water-flosses the teeth of the user [Step 312].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “water-flossing mouthpiece device” and “device” are interchangeable and refer to the water-flossing mouthpiece device 100 of the present invention.

Notwithstanding the foregoing, the water-flossing mouthpiece device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the water-flossing mouthpiece device 100 as shown in the FIGS. are for illustrative purposes only, and that many other sizes and shapes of the water-flossing mouthpiece device 100 are well within the scope of the present disclosure. Although the dimensions of the water-flossing mouthpiece device 100 are important design parameters for user convenience, the water-flossing mouthpiece device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A water-flossing mouthpiece device comprising:
a mouthpiece comprised of a teeth-receiving area, an opening, and a drainage tube;
an attachment point comprised of a flow control; and
a tubing in fluid communication with the attachment point and the mouthpiece.

2. The water-flossing mouthpiece device of claim 1, wherein the attachment point is comprised of a plurality of threads.

3. The water-flossing mouthpiece device of claim 1 further comprised of an adapter.

4. The water-flossing mouthpiece device of claim 3, wherein the adapter is comprised of a first opening of a first diameter and a second opening of a second diameter.

5. The water-flossing mouthpiece device of claim 4, wherein the first opening is comprised of a plurality of threads and the second opening is comprised of a plurality of threads.

6. The water-flossing mouthpiece device of claim 1, wherein the mouthpiece is comprised of a deformable material.

7. The water-flossing mouthpiece device of claim 1, wherein the flow control is comprised of a switch.

8. The water-flossing mouthpiece device of claim 1 further comprised of a pump device comprised of a pump, a battery, a reservoir, and a button.

9. The water-flossing mouthpiece device of claim 8, wherein the attachment point attaches to the pump device.

10. A water-flossing mouthpiece device comprising:
a mouthpiece comprised of a teeth-receiving area, an opening, and a drainage tube;
an attachment point comprised of a flow control;
a tubing in fluid communication with the attachment point and the mouthpiece, the tubing comprised of a compartment; and
a water-dissolving tablet.

11. The water-flossing mouthpiece device of claim 10, wherein the water-dissolving tablet is comprised of teeth-cleaning, bacteria-killing, and breathe-freshening tablet.

12. The water-flossing mouthpiece device of claim 11, wherein the tablet is comprised of a flavor.

13. The water-flossing mouthpiece device of claim 10, wherein the drainage tube is comprised of a cap.

14. The water-flossing mouthpiece device of claim 10, wherein the opening is positioned on the teeth-receiving area.

15. A method of using a water-flossing mouthpiece device, the method comprising the following steps:
providing a water-flossing mouthpiece device comprised of a mouthpiece comprised of a teeth receiving area and an opening, a tubing comprised of an attachment point, and a drainage tube;
securing the attachment point to a sink or a pump device;
placing a mouthpiece into a mouth of a user; and
placing the drainage tube into a sink bowl or a secondary area.

16. The method of using a water-flossing mouthpiece device of claim 15, wherein the water-flossing mouthpiece device is comprised of a compartment and a tablet.

17. The method of using a water-flossing mouthpiece device of claim 16 further comprised of a step of placing the tablet in the compartment.

18. The method of using a water-flossing mouthpiece device of claim 16, wherein the tablet cleans a tooth of the user, kills bacteria, and freshens a breath of the user.

19. The method of using a water-flossing mouthpiece device of claim 15, wherein the pump device is comprised of a pump and a reservoir.

20. The method of using a water-flossing mouthpiece device of claim 16 further comprised of an adapter.
